(19) United States
(12) Patent Application Publication
(10) Pub. No.: US 2026/0146643 A1
(43) Pub. Date: May 28, 2026

(54) VEHICLE SEAT ACTUATOR

(71) Applicant: NISSAN NORTH AMERICA, INC., Franklin, TN (US)

(72) Inventor: Devon Michael VOGT, Brighton, MI (US)

(21) Appl. No.: 18/957,132

(22) Filed: Nov. 22, 2024

(51) Int. Cl. F16C 1/16; B60N 2/22

(52) U.S. Cl. CPC F16C 1/16; B60N 2/2245

(57) ABSTRACT

A vehicle seat actuator includes a housing, a first operating part, a second operating part and a third operating part. The first operating part is movable relative to the housing between a rest position and an operated position of the first operating part in a first operating direction. The second operating part is movable relative to the housing between a rest position and an operated position of the second operating part in a second operating direction. The second operating direction is opposite of the first operating direction. The third operating part is disposed between the first and second operating parts to movably engage the first and second operating parts.

### BACKGROUND

### Technical Field

The present disclosure generally relates to a vehicle seat actuator. More specifically, the present disclosure relates to a vehicle seat actuator mechanically operating a vehicle seat.

### Background Information

Vehicles can be equipped with a vehicle seat actuator for actuating the vehicle seat, particularly one or more seats in the last row of seats to collapse the seat in order to expand a cargo area of the vehicle. The cargo area is expandable by collapsing one or more of the seats in the rear row of the vehicle into a flattened state such that the backs of the seats align substantially flush with the floor.

### SUMMARY

In view of the state of the known technology, one aspect of the present disclosure is to provide a vehicle seat actuator comprising a housing, a first operating part, a second operating part and a third operating part. The housing is configured to be supported to a vehicle body structure. The first operating part is movable relative to the housing between a rest position and an operated position of the first operating part in a first operating direction. The second operating part is movable relative to the housing between a rest position and an operated position of the second operating part in a second operating direction. The second operating direction is opposite of the first operating direction. The third operating part is disposed between the first and second operating parts to movably engage the first and second operating parts.

### BRIEF DESCRIPTION OF THE DRAWINGS

Referring now to the attached drawings which form a part of this original disclosure:

FIG. 1 is a perspective view of a cargo area of a vehicle that is equipped with a vehicle seat actuator in accordance with an illustrated embodiment;

FIG. 2 is a front perspective view of the vehicle seat actuator of FIG. 1;

FIG. 3 is an exploded perspective view of the vehicle seat actuator of FIGS. 1 and 2;

FIG. 4 is a rear perspective view of the vehicle seat actuator of FIGS. 1 to 3;

FIG. 5 is a cross-sectional view of the vehicle seat actuator in a rest position;

FIG. 6 is a cross-sectional view of the vehicle seat actuator in an actuated position;

FIG. 7 is a front perspective view of the vehicle seat actuator with an user operating surface depressed;

FIG. 8 is a cross-sectional view of a first modified vehicle seat actuator; and

FIG. 9 is a cross-sectional view of a second modified vehicle seat actuator.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

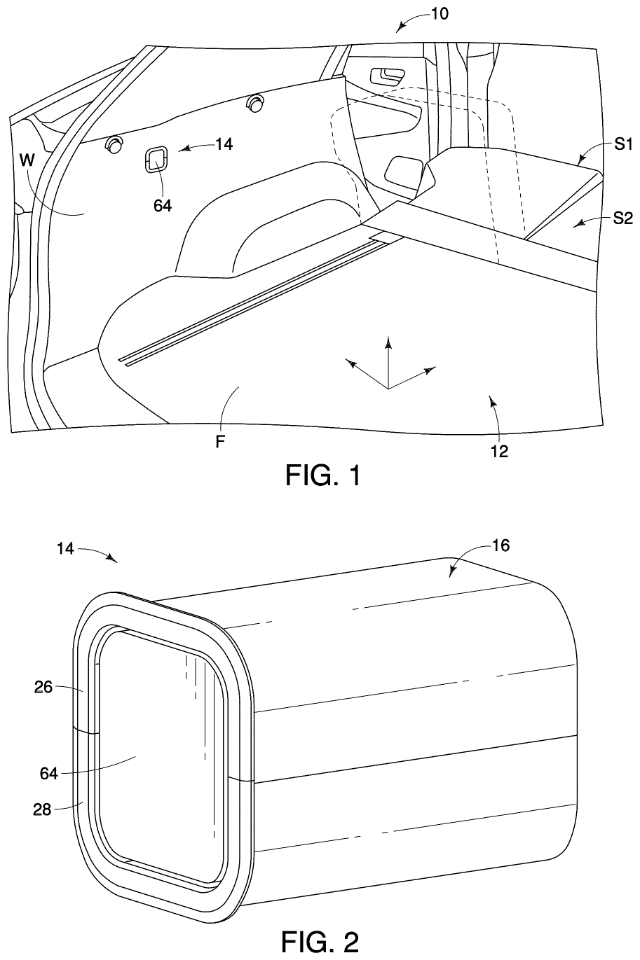

A portion of a vehicle 10 is illustrated. In particular, an interior space that defines a cargo area 12 of the vehicle 10 is illustrated. The cargo area 12 is an area for storing cargo (e.g. luggage) behind the vehicle's 10 last row of seats. The cargo area 12 is otherwise defined by a vehicle floor, a pair of sidewalls W and the vehicle's 10 rear hatch (not shown). The cargo area 12 is expandable by collapsing one or more of the seats in the rear row of the vehicle 10 into a flattened state such that the backs of the seats align substantially flush with the floor as shown in FIG. 1. In the illustrated embodiment, the vehicle 10 is equipped with a vehicle seat actuator 14 for actuating the vehicle seat(s) S1 and S2, particularly one or more seats in the last row of seats to collapse the seat(s) S1 and S2 in order to expand the cargo area 12. The vehicle 10 of the illustrated embodiment can be a sports utility vehicle or a minivan. However, it will be apparent to those skilled in the vehicle field from this disclosure that the vehicle 10 can be other types of vehicles that are equipped with the seat actuator 14 for collapsing a rear row of seats.

The vehicle seat actuator 14 is provided on one or both of the sidewalls W. The vehicle 10 can be equipped with a pair of vehicle seat actuators 14 for operating one of the left and right seats in the rear row. In the illustrated embodiment, the vehicle seat actuator 14 actuates the rear drivers' side seat S1 as shown and will be described as operating the seat S1. However, it will be apparent to those skilled in the vehicle field from this disclosure that the vehicle seat actuator 14 can be modified to operate both seats S1 and S2 in the last row concurrently.

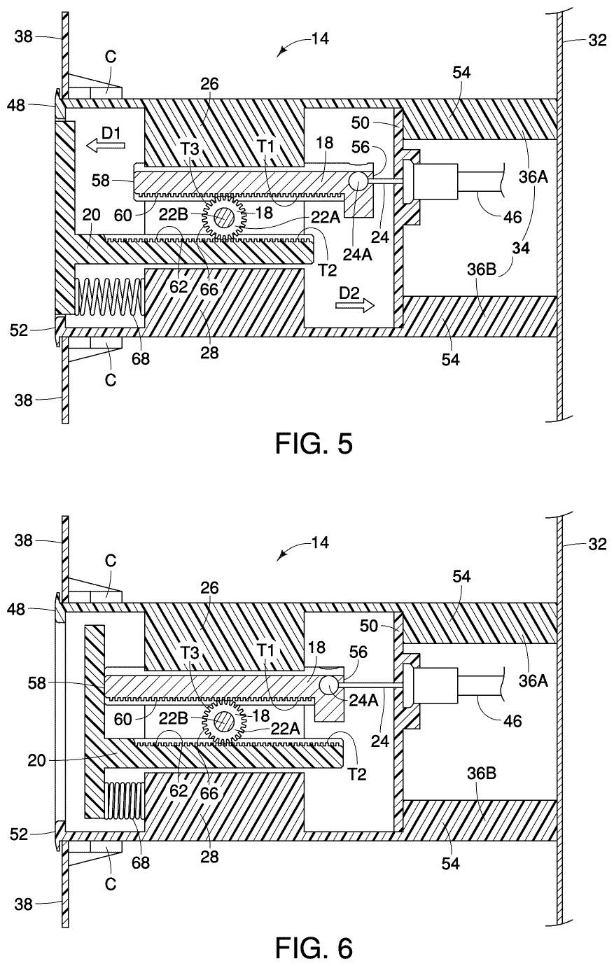

The vehicle seat actuator 14 comprises a housing 16, a first operating part 18 and a second operating part 20. The first operating part 18 is movable relative to the housing 16 between a rest position and an operated position of the first operating part 18 in a first operating direction D1 (see FIGS. 5 and 6). The second operating part 20 is movable relative to the housing 16 between a rest position and an operated position of the second operating part 20 in a second operating direction D2 that is opposite of the first operating direction D1 (see FIGS. 5 and 6). The vehicle seat actuator 14 further comprises a third operating part 22 disposed between the first and second operating parts 18 and 20 to movably engage the first and second operating parts 18 and 20, as will be further described below.

One of the first and second operating parts 18 and 20 is configured to be connected to a cable 24 for operating the vehicle seat S1. The other of the first and second operating parts 18 and 20 is configured to be operable by a user to first operating part 18 is connected to a cable 24 for operating the vehicle seat S1. In the illustrated embodiment, the first operating part 18 (a top movable part) is coupled to the cable 24 for collapsing the vehicle seat S1. When the cable 24 is pulled by the first operating part 18, the cable 24 collapses the vehicle seat S1 as necessary. However, it will be apparent to those skilled in the vehicle field from this disclosure that the cable 24 can alternatively be coupled to the second operating part 20 (a bottom movable part) for operating the vehicle seat S1.

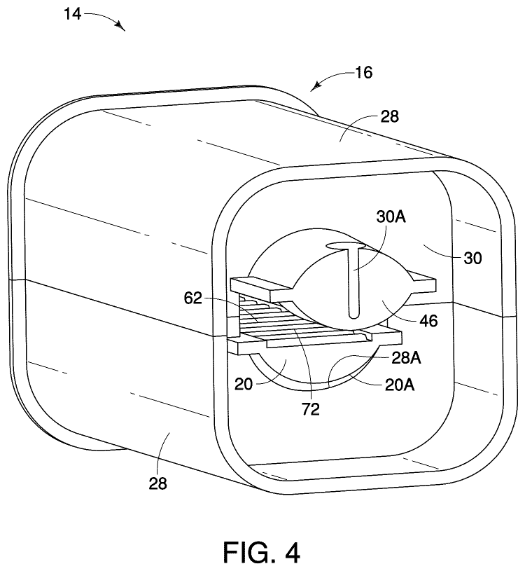

Referring to FIGS. 2 to 4, the housing 16 comprises a first housing part 26 having a first groove 26A. The housing 16 further comprises a second housing 16 part having a second groove 28A. The first operating part 18 is movable with respect to the first housing part 26 along the first groove 26A. The second operating part 20 is movable with respect to the second housing 16 part along the second groove 28A. The housing 16 forms an interior that houses the first, second and third operating parts 18, 20 and 22. The housing 16 further comprises a rear wall 30 having an opening 30A. The rear wall 30 is preferably a two-part structure that is defined by portions of the first and second housing 16 parts, as seen in FIG. 4. The cable 24 is a release cable 24 that extends through the opening 30A of the rear wall 30 towards a vehicle body structure 32 such as a metal panel that forms part of the vehicle body of the vehicle 10.

Referring to FIGS. 4 to 6, the housing 16 is configured to be supported to the vehicle body structure 32. In the illustrated embodiment, the vehicle seat actuator 14 further includes a base 34 that supports the housing 16 to the vehicle body structure 32. The base 34 can be a pair of standoffs 36A and 36B that are provided to the housing 16 to support the housing 16 to the metal panel. The standoffs 36A and 36B can be molded plastic that is integral with the housing 16, or the standoffs 36A and 36B can be metal standoffs 36A and 36B. In the illustrated embodiment, the standoffs 36A and 36B are a pair of extensions connecting the housing 16 with the metal panel, preferably one standoff provided at one of the first and second housing 16 parts to the housing 16. Therefore, the standoffs 36A and 36B form a bracket supporting the housing 16 to the metal panel. Alternatively, the standoffs 36A and 36B can be a single extension or another type of support structure for supporting the housing 16 to the metal panel. It will also be apparent to those skilled in the vehicle field from this disclosure that the housing 16 can be supported to the metal panel directly or via other supporting structures as needed and/or desired.

As seen in FIGS. 5 and 6, the housing 16 is also supported to a vehicle trim, such as a plastic panel or a lug trim 38 that is provided over the metal panel. The plastic panel forms part of the interior wall of the vehicle 10. The vehicle seat actuator 14 preferably has a flush appearance with the lug trim 38 when installed onto the vehicle 10. The housing 16 can be supported to the lug trim 38 by one or more fasteners. Therefore, the housing 16 can be clipped to the lug trim 38 by clips C or fasteners. The lug trim 38 can be provided with fabric such as felt to decrease vibration between the housing 16 and the lug trim 38.

As best seen in FIGS. 4 to 7, the rear wall 30 includes an interior side facing the interior of the housing 16 and an exterior side facing the metal panel (the vehicle body structure 32). As stated, the rear wall 30 includes the opening 30A for receiving the cable 24 into the interior of the housing 16. Therefore, the cable 24 extends through the opening 30A of the rear wall 30. The exterior side includes a holder 46 for holding the cable 24 to the rear wall 30. For example, the holder 46 can have a groove for receiving the cable 24 in an interference fit.

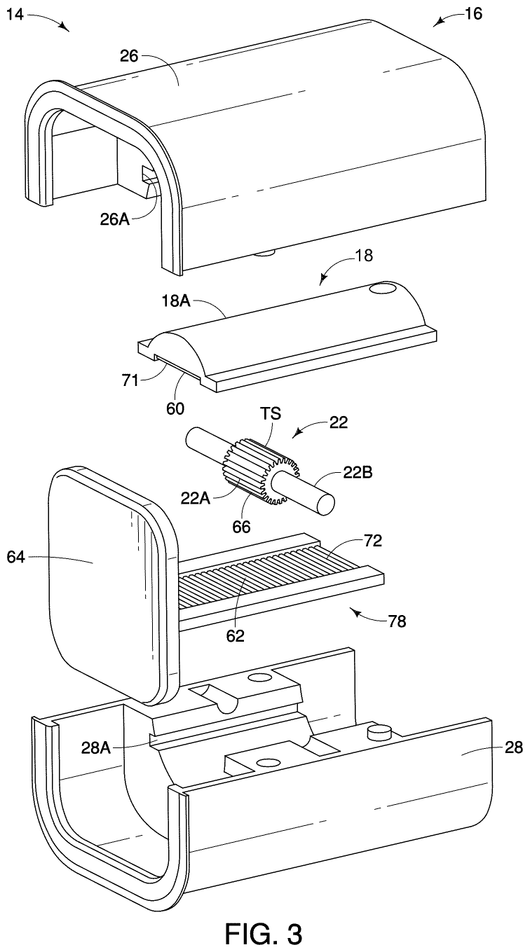

Referring to FIGS. 3, 5 and 6, the first housing part 26 defines a top of the housing 16 when the vehicle seat actuator 14 is installed onto the vehicle 10. The first housing part 26 is supported to the lug trim 38 at a first end 48 by a clip C. The first housing part 26 is supported to the metal panel at a second end 50 by one of the standoffs 36A and 36B of the base 34. The second housing 16 part defines a bottom of the housing 16 when the vehicle seat actuator 14 is installed onto the vehicle 10. The second housing 16 part is similarly supported to the lug trim 38 at a first end 52 by a clip C. The second housing 16 part is also supported to the metal panel at a second end 54 by one of the standoffs 36A and 36B of the base 34.

As best seen in FIGS. 5 and 6, the first housing part 26 includes the first groove 26A that interacts with the first operating part 18. The second housing 16 part includes the second groove 28A that interacts with the second operating part 20. As shown, the first operating part 18 is movable in the first groove 26A between the rest and operated positions of the first operating part 18. Preferably, the first operating part 18 slides in the first groove 26A during operation. The first operating part 18 has a smooth side 18A (as seen in FIG. 3) that slides against the first groove 26A. The second operating part 20 is movable in the second groove 28A between the rest and operated positions of the second operating part 20. Preferably, the second operating part 20 slides in the second groove 28A during operation. Similar to the first operating part 18, the second operating part 20 has a smooth side 20A (as seen in FIG. 4) that slides against the second groove 28A. In the illustrated embodiment, the first and second grooves 26 and 28A are sized and dimensioned to correspond to the size and dimensions of the first and second operating parts 18 and 20.

As stated, the cable 24 is operatively connected to the first operating part 18 such that the first operating part 18 pulls the cable 24 into the housing 16 when the first operating part 18 moves in the first operating direction D1. As shown, the cable 24 has a first end 24A that is positioned inside the interior space of the housing 16 to be attached to the first operating part 18. In particular, the cable 24 has a head that is received by the first operating part 18 in a conventional manner, such as by snap fit or interference fit. The cable 24 has a second end (not shown) that extends outside of the interior space and is exterior of the housing 16. The cable 24 has an elongated body that is fitted to the holder 46 on the rear wall 30 to help anchor the cable 24 with respect to the housing 16.

As seen in FIGS. 5 and 6, the first operating part 18 moves away from the vehicle body structure 32 when moving in the first operating direction D1 from the rest position to the actuated position. The first operating part 18 has a first end 56 that receives the cable 24 that moves away from the vehicle body structure 32 when the first operating part 18 moves in the first operating direction D1. The first operating part 18 has a second end 58 that is spaced from the second operating part 20 or a front of the housing 16. As will be further described below, the second operating part 20 moves towards to the vehicle body structure 32 as the first operating part 18 moves away from the vehicle body structure 32 such that the first and second operating parts 18 and 20 will no longer be spaced when in the actuated position of these respective members.

The first operating part 18 has a first serrated surface 60. In particular, the first operating part 18 has an elongated track having the first serrated surface 60 defined by a plurality of first teeth T1. The elongated track is movable with respect to the first groove 26A of the first housing part 26. In this way, the first operating part 18 can be a rod or a rack. The first teeth T1 engage with the third teeth T3 of the third operating part 22 (the pinion 22A) that rotates as the first and second operating parts 18 and 20 movably engage the pinion 22A.

The second operating part 20 moves towards the vehicle body structure 32 in the second operating direction D2, as seen in FIGS. 5 and 6. The second operating part 20 has a second serrated surface 62. The second operating part 20 has an elongated track having the second serrated surface 62 defined by a plurality of second teeth T2 that engages with the third operating part 22 concurrently as the first operating part 18 engages the third operating part 22. Therefore, the second operating part 20 is a rod or a rack that engages the pinion 22A.

As best seen in FIG. 4, the second operating part 20 has a first end that is spaced from the rear wall 30 when in the rest position. The second operating part 20 is operable by a user to move towards the rear wall 30 when operated in the second operating direction D2 from the rest position to the actuated position of the second operating part 20. In the illustrated embodiment, the second operating part 20 has a user operating surface 64 that is operated by a user to move the second operating part 20 in the second operating direction D2. Therefore, the user operating surface 64 is an outer surface of the vehicle seat actuator 14. As seen in FIGS. 2 and 5, the user operating surface 64 of the second operating part 20 is substantially flush with an exterior of the housing 16 when the second operating member is at the rest position. Therefore, the vehicle seat actuator 14 of the illustrated embodiment is provided as a button that is pushed to operate the cable 24 and collapse the vehicle seat S1.

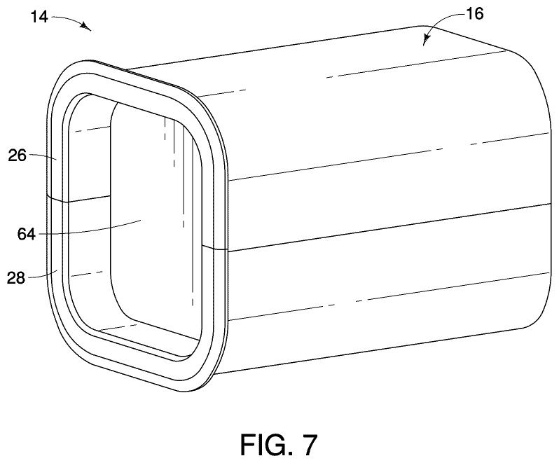

As seen in FIGS. 6 and 7, the user operating member is depressed into the housing 16 when the second operating member moves in the second operating direction D2. As stated, the third operating part 22 concurrently engages with the first and second teeth T2 such that the third operating part 22 rotates at a stationary location in the housing 16 while the first and second operating parts 18 and 20 move. Therefore, the first operating part 18 concurrently moves in the first operating direction D1 as the second operating part 20 moves in the second operating direction D2 upon user operation as the pinion 22A movably engages the first and second serrated surfaces 60 and 62.

When the second operating part 20 is operated by the user, the second operating member engages with the third operating part 22 which rotates to cause the first operating part 18 to move and to pull the cable 24 into the housing 16. In the illustrated embodiment, the travel distance of the first and second operating parts 18 and 20 between their respective rest and actuated positions is preferably five (5) millimeters or greater. That is, the first operating part 18 travels a distance of preferably five (5) millimeters or greater when traveling in the first operating direction D1. The second operating member travels a distance of preferably five (5) millimeters or greater when traveling in the second operating direction D2.

The third operating part 22 is disposed between the first and second operating parts 18 and 20 to movably engage the first and second operating parts 18 and 20. As stated, the third operating part 22 has a third serrated surface operatively engaging the first and second serrated surfaces 60 and 62. Also as stated, the third operating part 22 has a plurality of third teeth T3 engaging the first and second serrated surfaces 60 and 62. The pinion 22A rotatably engages the first and second teeth T2 as the first and second operating parts 18 and 20 move with respect to the housing 16.

As best seen in FIG. 3, the third operating part 22 includes a serrated pinion 22A provided on a pin 22B that sits on the first and second housing 16 parts. The serrated pinion 22A has the third teeth T3 and can be made of plastic or metal. The pin 22B of the third operating part 22 is preferably made of metal. The interior of the housing 16 can be provided with lubrication to smooth the interaction between the first, second and third operating parts 18, 20 and 22.

As best seen in FIGS. 5 and 6, the vehicle seat actuator 14 further comprises a biasing member 68 biasing one of the first and second operating parts 18 and 20 towards the rest position of the vehicle seat actuator 14 in which each of the first and second operating parts 18 and 20 are at their respective rest positions. In particular, the biasing member 68 is operatively connected to the second operating part 20 and the housing 16 to bias the second operating part 20 towards the rest position of the second operating part 20. As shown, the biasing member 68 is a compression spring provided between the user operating surface 64 and the second housing 16 part. That is, the biasing member 68 biases the second operating part 20 with respect to the housing 16. The biasing member 68 is disposed in a space between the user operating surface 64 and the second housing 16 part.

It will be apparent to those skilled in the vehicle field from this disclosure that the biasing member 68 can alternatively be provided in a space between the first operating part 18 and the first housing part 26 to bias the first operating part 18 into the rest position. As the first and second operating parts 18 and 20 are engaged via the third operating part 22, the first and second operating parts 18 and 20 are concurrently in their respective rest positions and their respective actuated positions.

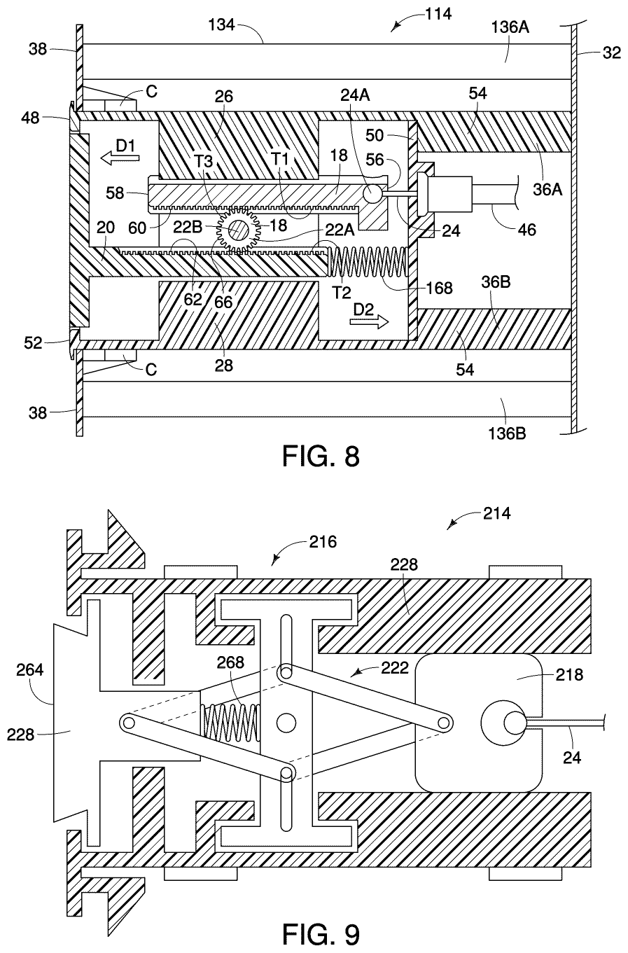

Referring now to FIG. 8, a first modified vehicle seat actuator 114 is illustrated. The first modified seat actuator 114 can be provided to the vehicle 10 to collapse the vehicle seat S1 as described above. Due to the similarity between the first modified vehicle seat actuator 14 and the vehicle seat actuator 14, all identical components of the first modified vehicle seat actuator 14 and the vehicle seat actuator 14 will receive the same reference numerals. All modified components of the first modified vehicle seat actuator 14 and the vehicle seat actuator 14 will receive the same reference numerals but increased by 100.

The first modified vehicle seat actuator 114 is basically identical to the vehicle seat actuator 14 having a housing 16, a first operating part 18, a second operating part 20, and a third operating part 22 that are basically identical to those described for the vehicle seat actuator 14. In the first modified vehicle seat actuator 14, a modified base 134 of the vehicle seat actuator 14 is provided between the lug trim 38 and the vehicle body structure 32 or the metal panel. While the standoff of the vehicle seat actuator 14 is provided between the housing 16 and the metal panel, the standoff of the first modified vehicle seat actuator 14 extends between the lug trim 38 and the metal panel. As shown, the housing 16 is supported to the lug trim 38 by clips or fasteners as needed. In this way, the housing 16 is supported to the lug trim 38 and to the vehicle body structure 32. Preferably, the standoffs 136A and 136B of the first modified vehicle seat actuator 114 is a pair of molded plastic extensions that form a bracket for supporting the housing 16 to the lug trim 38.

In the first modified vehicle seat actuator 114 includes a biasing member 168 that is provided against the second operating part 20 and the rear wall 30 of the housing 16. The biasing member 68 biases the second operating part 20 into the rest position with the user operating surface 64 in the not depressed state. Therefore, it will be apparent to those skilled in the vehicle field from this disclosure that the biasing member 68 can be provided to the vehicle seat actuator 14 to bias either the first or second operating parts 18 and 20 and a portion of the housing 16.

Referring to FIG. 9, a second modified vehicle seat actuator 214 is illustrated. The second modified vehicle seat actuator 14 can be provided to the vehicle 10 to collapse the vehicle seat S1 as described above. Instead of a rack and pinion 22A mechanism as described for the vehicle seat actuator 14, the second modified vehicle seat actuator 14 utilizes a linkage 222 that moves a first modified operating part 218 and a second modified operating part 220. The first modified operating part 218 is attachable to a cable 24 for actuating a vehicle seat S1. The second modified operating part 220 includes a user operating surface 264. The linkage 222 is operatively connected to the first and second modified operating parts 218 and 220 such that when the second modified operating part 220 is operated (depressed by a user), the linkage 222 moves to pull the first operating part 18 and thereby the cable 24. As shown, the second modified vehicle seat actuator 214 can have a modified housing 216 be integrally provided with clips and fasteners to fasten the second modified vehicle seat actuator 214 to the lug trim 38 as needed and/or desired.

Due to the similarity between the second modified vehicle seat actuator 214 and the vehicle seat actuator 14, all identical components of the second modified vehicle seat actuator 214 and the vehicle seat actuator 14 will receive the same reference numerals. All modified components of the second modified vehicle seat actuator 214 and the vehicle seat actuator 14 will receive the same reference numerals but increased by 200.

In understanding the scope of the present invention, the term “comprising” and its derivatives, as used herein, are intended to be open ended terms that specify the presence of the stated features, elements, components, or groups, but do not exclude the presence of other unstated features, elements, components, or groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle seat actuator. Accordingly, these terms, as utilized to describe the present invention should be interpreted relative to a vehicle equipped with the vehicle seat actuator.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A vehicle seat actuator system comprising:
a vehicle seat;
a housing configured to be supported to a vehicle body structure;
a first operating part movable relative to the housing between a rest position and an operated position of the first operating part in a first operating direction;
a second operating part movable relative to the housing between a rest position and an operated position of the second operating part in a second operating direction that is opposite of the first operating direction; and
a third operating part disposed between the first and second operating parts to movably engage the first and second operating parts_
one of the first and second operating parts being connected to a cable for actuating the vehicle seat.

2. The vehicle seat actuator system according to claim 1, wherein
the first operating part has a first serrated surface,
a second operating part has a second serrated surface, and
the third operating part has a third serrated surface operatively engaging the first and second serrated surfaces.

3. (canceled)

4. The vehicle seat actuator system according to claim 1, wherein
the third operating part is a pinion having a plurality of teeth engaging the first and second serrated surfaces.

5. The vehicle seat actuator system according to claim 4, wherein
the first operating part moves away from the vehicle body structure in the first operating direction,
the second operating part moves towards the vehicle body structure in the second operating direction.

6. The vehicle seat actuator system according to claim 5, wherein the cable is operatively connected to the first operating part such that the first operating part pulls the cable into the housing when the first operating part moves in the first operating direction.

7. The vehicle seat actuator system according to claim 6, wherein
the second operating part has a user operating surface that is operated by a user to move the second operating part in the second operating direction.

8. The vehicle seat actuator system according to claim 7, wherein
the first operating part concurrently moves in the first operating direction as the second operating part moves in the second operating direction upon user operation as the pinion movably engages the first and second serrated surfaces.

9. The vehicle seat actuator system according to claim 8, further comprising
a biasing member biasing one of the first and second operating parts towards a rest position of the vehicle seat actuator in which each of the first and second operating parts at the respective rest positions.

10. The vehicle seat actuator system according to claim 9, wherein
the biasing member is operatively connected to the second operating part and the housing to bias the second operating part towards the rest position of the second operating part.

11. The vehicle seat actuator system according to claim 10, wherein
the user operating surface of the second operating member is substantially flush with an exterior of the housing when the second operating member is at the rest position,
the user operating member being depressed into the housing when the second operating member moves in the second operating direction.

12. The vehicle seat actuator system according to claim 9, wherein
the housing comprises a rear wall having an opening, the release cable extending through the opening of the rear wall towards the vehicle body structure.

13. The vehicle seat actuator system according to claim 12, wherein
the housing further comprises a first housing part having a first groove, the first operating member being movable with respect to the first housing part along the first groove.

14. The vehicle seat actuator system according to claim 13, wherein
the housing further comprises a second housing part having a second groove, the second operating part being movable with respect to the second housing part along the second groove.

15. The vehicle seat actuator system according to claim 4, wherein
the first operating part has an elongated track having the first serrated surface defined by a plurality of first teeth,
the second operating part has an elongated track having the second serrated surface defined by a plurality of second teeth.

16. The vehicle seat actuator system according to claim 15, wherein
the pinion rotatably engages the first and second teeth as the first and second operating parts move with respect to the housing.

17. A vehicle seat actuator comprising:
a housing configured to be supported to a vehicle body structure;
a first operating part movable relative to the housing between a rest position and an operated position of the first operating part in a first operating direction;
a second operating part movable relative to the housing between a rest position and an operated position of the second operating part in a second operating direction that is opposite of the first operating direction; and
a third operating part disposed between the first and second operating parts to movably engage the first and second operating parts,
the housing comprising a first groove formed in a first interior surface of the housing and a second groove formed in a second interior surface of the housing, the first operating member being movable with respect to the housing along the first groove, and the second operating part being movable with respect to the housing along the second groove.
